(19) United States
(12) Patent Application Publication
(10) Pub. No.: US 2007/0189466 A1
(43) Pub. Date: Aug. 16, 2007

(54) Method and apparatus for disabling advanced call features during an emergency call

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/344,634

(22) Filed: Jan. 31, 2006

(51) Int. Cl. H04M 11/04

(52) U.S. Cl. 379/37

(57) ABSTRACT

A method and apparatus for disabling advanced call forwarding service features when a subscriber places an emergency call, e.g., an E911 call, during the E911 call until a normal call disconnect signaling protocol message is received for the E911 call are disclosed. In addition, the advanced call forwarding service features will remain disabled for a specified period by the network if a normal call disconnect signaling protocol message is not received for the E911 call.

The present invention relates generally to communication networks and, more particularly, to a method and apparatus for disabling advanced call features during an emergency call, e.g., an Enhanced 911 (E911)call, in communication networks, e.g. packet networks such as Voice over Internet Protocol (VoIP) networks.

### BACKGROUND OF THE INVENTION

VoIP network providers are required to provide Enhanced 911 (E911) services that are equivalent in reliability and performance to the Public Switched Telephone Network (PSTN) counterpart. Failure to complete call setup of these emergency calls due to a network condition can have serious or even fatal consequences. In particular, if a caller hangs up during an E911 call, the PSAP operator must be able to return a call to them on an immediate basis. However, VoIP services also provide enhanced service features that enable a subscriber to forward their calls to other phone numbers. These enhanced features would prevent an emergency dispatcher at a Public Safety Answering Point (PSAP) from being able to return a call to a subscriber that originated a call from a VoIP endpoint that has advanced call forwarding service features enabled to forward calls.

Therefore, a need exists for a method and apparatus for disabling advanced call features during an emergency call, e.g., Enhanced 911 (E911) call, in a packet network, e.g., a VoIP network.

### SUMMARY OF THE INVENTION

In one embodiment, the present invention provides a method to disable advanced call forwarding service features when a subscriber places an emergency call, e.g., an E911 call, during the E911 call until a normal call disconnect signaling protocol message is received for the E911 call; otherwise, the advanced call forwarding service features will remain disabled for a specified period by the network.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VOIP) network related to the present invention;

FIG. 2 illustrates an example of disabling advanced call features during an emergency call, e.g., an Enhanced 911 call (E911), in a VoIP network of the present invention;

FIG. 3 illustrates a flowchart of a method for disabling advanced call features during an emergency call, e.g., an Enhanced 911 call (E911), in a packet network, e.g., a VoIP network, of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

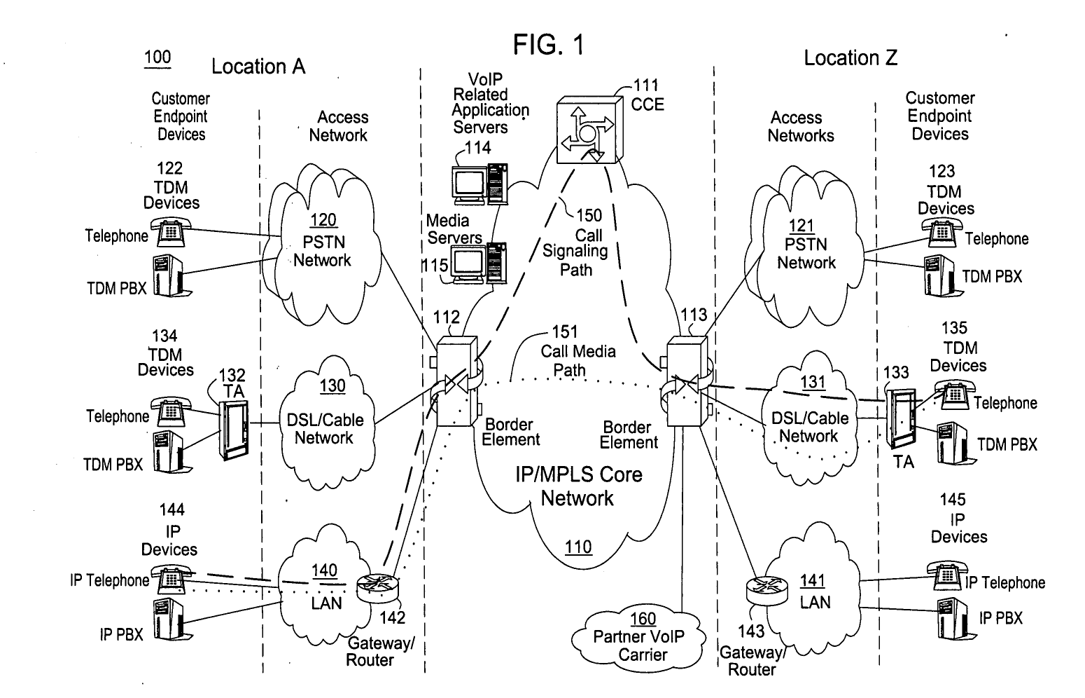

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, teleconference bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

VoIP network providers are required to provide Enhanced 911 (E911) services that are equivalent in reliability and performance to the Public Switched Telephone Network (PSTN) counterpart. Failure to complete call setup of these emergency calls due to a network condition can have serious or even fatal consequences. In particular, if a caller hangs up during an E911 call, the PSAP operator must be able to return a call to them on an immediate basis. VoIP services also provide enhanced service features that enable a subscriber to forward their calls to other phone numbers. These enhanced features would prevent an emergency dispatcher at a Public Safety Answering Point (PSAP) from being able to return a call to a subscriber that originated a call from a VoIP endpoint that has advanced call forwarding service features enabled to forward calls. E911 is an emergency response service that allows emergency personnel at a Public Safety Answering Point (PSAP) to respond to the emergency call and receive the location of a caller placing the emergency call and the calling party phone number. A PSAP is an emergency response center that is responsible for answering E911 calls for emergency assistance from police, fire and ambulance services.

To address this need, the present invention provides a method to disable advanced call forwarding service features when a subscriber places an emergency call, e.g., an E911 call, during the E911 call until a normal call disconnect signaling protocol message is received for the E911 call; otherwise, the advanced call forwarding service features will remain disabled for a specified period by the network.

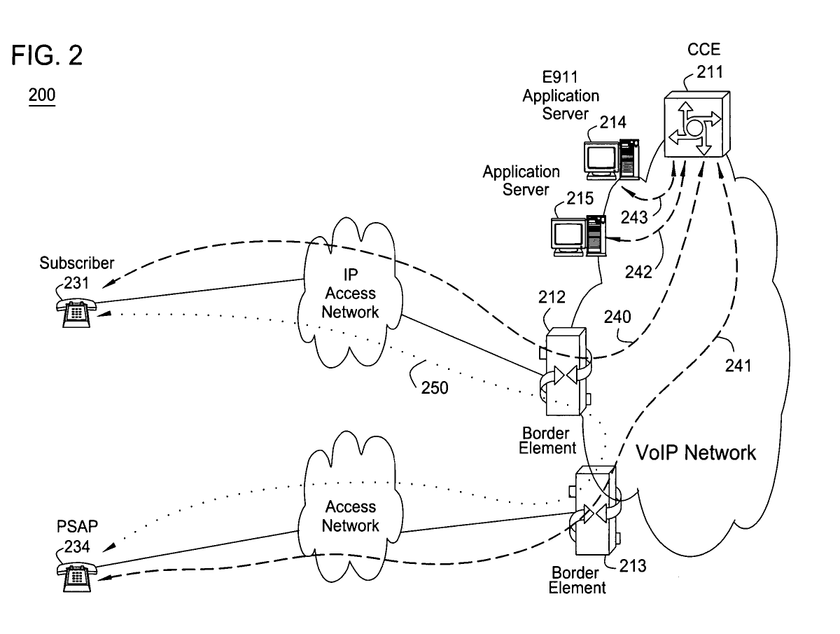

FIG. 2 illustrates an example 200 of disabling advanced call features during an emergency call, e.g., an Enhanced 911 call (E911), in a VoIP network of the present invention. In FIG. 2, subscriber 231 sends an E911 call setup message to CCE 211 via BE 212 using flow 240. Upon receiving the E911 call setup message, CCE 211 finds out that the call is an E911 call and identifies the appropriate PSAP, e.g., PSAP 234, in which the call is to be terminated. CCE 211 identifies PSAP 234 by communicating with E911 AS 214 using flow 243. In one embodiment, E911 AS 214 performs a lookup of the subscriber's service address using the subscriber's phone number and then uses the obtained service address to identify PSAP 234 to handle the E911 call for the service address. In addition, CCE 211 identifies all advanced call service features subscribed by the subscriber.

In particular, CCE 211 communicates with AS 215 to obtain all the advanced call forwarding service features that have been enabled by the subscriber at the time. Advanced call forwarding service features include all service features that redirects or forwards an incoming call destined to the subscriber endpoint to a different endpoint such as a voice mailbox or other terminating endpoints configured by the subscriber. CCE 211 sends the E911 call setup message to PSAP 234 via BE 213 using flow 241 for call establishment. BE 213 successfully completes the call to PSAP 234. CCE 211 disables all enabled advanced call forwarding service features that are active at the time by communicating with AS 215 using flow 242.

Once the call is successfully established, subscriber 231 and PSAP 234 communicate with each other using media flow 250. The call can be terminated by either subscribe 231 or PSAP 234 using a call disconnect message via flow 240 or flow 241 respectively. The disabled advanced call forwarding service features will be reactivated when a normal call disconnect signaling message is received by CCE 211; otherwise, these disabled advanced call forwarding service features will remain disabled for a predefined period of time after the termination of the E911 call. The predefined period of time (e.g., 10 minutes, 20 minutes, and so on) is a configurable parameter set by the network provider. A normal call disconnect is characterized by the completion of a call disconnect process with no error conditions in the processing of the call disconnect signaling messages. CCE 211 communicates with AS 215 using flow 242 to reactivate the previously disabled advanced call forwarding service features.

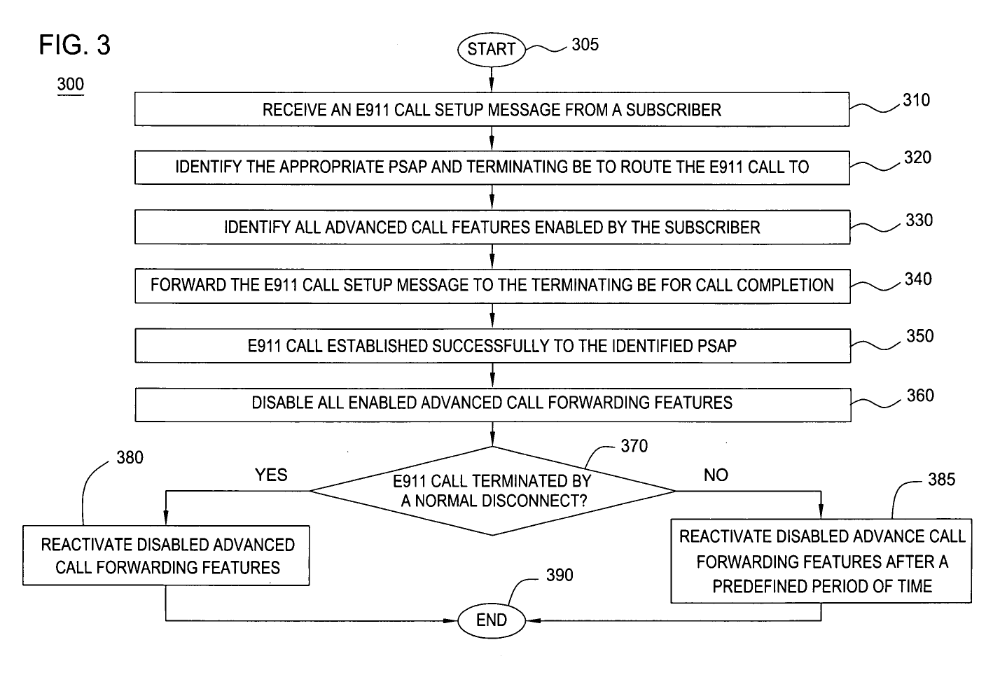

FIG. 3 illustrates a flowchart of a method 300 for disabling advanced call features during an emergency call, e.g., Enhanced 911 call (E911), in a packet network, e.g., a VoIP network, of the present invention. Method 300 starts in step 305 and proceeds to step 310.

In step 310, the method receives an E911 call setup message. For example, the E911 call setup message is received by a CCE.

In step 320, the method identifies the appropriate PSAP and the terminating BE for call completion. For example, the PSAP and the terminating BE are identified by the CCE. Specifically, the appropriate PSAP is identified by the CCE by communicating with an E911 AS. In one embodiment, the E911 AS performs a lookup of the subscriber's service address using the subscriber's phone number and then uses the obtained service address to identify the appropriate PSAP to handle the E911 call for the service address.

In step 330, the method identifies all advanced call service features that have been enabled by the subscriber at the time. For example, these enabled advanced call service features are identified by the CCE by communicating with an AS. Specifically, CCE identifies all advanced call forwarding service features that are active at the time. Advanced call forwarding service features include all service features that redirects or forwards an incoming call destined to the subscriber endpoint to a different endpoint such as a voice mailbox or other terminating endpoints configured by the subscriber.

In step 340, the method forwards the E911 call setup message towards the identified PSAP via a terminating BE to complete the call. For example, the E911 call setup message is forwarded toward the identified PSAP by the CCE.

In step 350, the method completes successfully the E911 call to the identified PSAP. For example, the E911 call is completed by the CCE via the terminating BE.

In step 360, the method disables all identified advanced call forwarding service features during the entire E911 call between the PSAP and the subscriber. For example, the identified advanced call forwarding service features are disabled by the CCE.

In step 370, the method checks if a normal disconnect is received for the termination of the E911 call. The termination of the E911 call by a normal disconnect is monitored and checked by the CCE. If a normal disconnect is received for the termination of the E911 call, the method proceeds to step 380; otherwise, the method proceeds to step 385. For example, a normal call disconnect is characterized by the completion of a call disconnect process with no error conditions in the processing of the call disconnect signaling messages.

In step 380, the method reactivates all previously disabled advanced call forwarding service features. For example, the previously disabled advanced call forwarding service features are reactivated by the CCE by communicating with an AS.

In step 385, the method reactivates all previously disabled advanced call forwarding service features only after a predefined period of time after the E911 call termination. The predefined period of time is a configurable parameter set by the network provider. For example, the previously disabled advanced call forwarding service features will be reactivated by the CCE by communicating with an AS. The method ends in step 390.

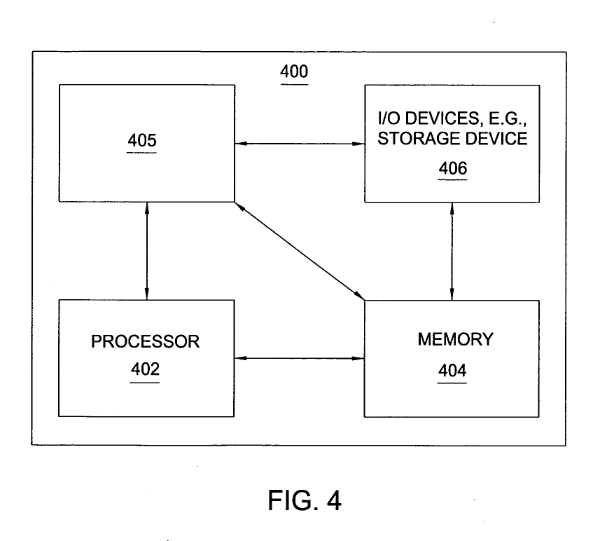

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for disabling advanced call features during an emergency call, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for disabling advanced call features during an emergency call can be loaded into memory 404 and executed by processor 402 to implement the functions as discussed above. As such, the present process 405 for disabling advanced call features during an emergency call (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for disabling an advanced call feature during an emergency call in a communication network, comprising:
receiving an emergency call setup message from an endpoint device for establishing an emergency call, where at least one call forwarding service feature is associated with said endpoint device;
deactivating said at least one call forwarding service feature during said emergency call; and
reactivating said at least one call forwarding service feature after a completion of said emergency call.

2. The method of claim 1, wherein said communication network is a Voice over Internet Protocol (VOIP) network or a Service over Internet Protocol (SOIP) network.

3. The method of claim 1, wherein said emergency call is an Enhanced 911 (E911)call.

4. The method of claim 1, wherein said receiving comprises:
receiving said emergency call setup message from said endpoint device;
determining said at least one call forwarding service feature that is currently enabled; and
establishing said emergency call between said endpoint device and a Public Safety Answering Point (PSAP).

5. The method of claim 1, wherein said reactivating comprises:
reactivating said at least one call forwarding service feature immediately after said emergency call is completed with a normal disconnect process; or reactivating said at least one call forwarding service feature after a predefined period of time of the completion of said emergency call if said emergency call is not completed with said normal disconnect process.

6. The method of claim 5, wherein said normal disconnect process is characterized by said completion of said call disconnect process with no error conditions in a processing of one or more call disconnect signaling messages.

7. The method of claim 1, wherein said emergency call setup message is received by a Call Control Element (CCE).

8. The method of claim 1, wherein said at least one call forwarding service feature is deactivated by a Call Control Element (CCE) by communicating with an Application Server (AS).

9. The method of claim 1, wherein said at least one call forwarding service feature is reactivated by a Call Control Element (CCE) by communicating with an Application Server (AS).

10. A computer-readable medium having stored thereon a plurality of instructions, the plurality of instructions including instructions which, when executed by a processor, cause the processor to perform the steps of a method for disabling an advanced call feature during an emergency call in a communication network, comprising:
receiving an emergency call setup message from an endpoint device for establishing an emergency call, where at least one call forwarding service feature is associated with said endpoint device;
deactivating said at least one call forwarding service feature during said emergency call; and
reactivating said at least one call forwarding service feature after a completion of said emergency call.

11. The computer-readable medium of claim 10, wherein said communication network is a Voice over Internet Protocol (VOIP) network or a Service over Internet Protocol (SoIP) network.

12. The computer-readable medium of claim 10, wherein said emergency call is an Enhanced 911 (E911)call.

13. The computer-readable medium of claim 10, wherein said receiving comprises:
receiving said emergency call setup message from said endpoint device;
determining said at least one call forwarding service feature that is currently enabled; and
establishing said emergency call between said endpoint device and a Public Safety Answering Point (PSAP).

14. The computer-readable medium of claim 10, wherein said reactivating comprises:
reactivating said at least one call forwarding service feature immediately after said emergency call is completed with a normal disconnect process; or
reactivating said at least one call forwarding service feature after a predefined period of time of the completion of said emergency call if said emergency call is not completed with said normal disconnect process.

15. The computer-readable medium of claim 14, wherein said normal disconnect process is characterized by said completion of said call disconnect process with no error conditions in a processing of one or more call disconnect signaling messages.

16. The computer-readable medium of claim 10, wherein said emergency call setup message is received by a Call Control Element (CCE).

17. The computer-readable medium of claim 10, wherein said at least one call forwarding service feature is deactivated by a Call Control Element (CCE) by communicating with an Application Server (AS).

18. The computer-readable medium of claim 10, wherein said at least one call forwarding service feature is reactivated by a Call Control Element (CCE) by communicating with an Application Server (AS).

19. An apparatus for disabling an advanced call feature during an emergency call in a communication network, comprising:
means for receiving an emergency call setup message from an endpoint device for establishing an emergency call, where at least one call forwarding service feature is associated with said endpoint device;
means for deactivating said at least one call forwarding service feature during said emergency call; and
means for reactivating said at least one call forwarding service feature after a completion of said emergency call.

20. The apparatus of claim 19, wherein said communication network is a Voice over Internet Protocol (VOIP) network or a Service over Internet Protocol (SoIP) network.
